(19) United States
(12) Patent Application Publication
(10) Pub. No.: US 2021/0189027 A1
(43) Pub. Date: Jun. 24, 2021

(54) RESIN PARTICLES AND METHOD FOR PRODUCING RESIN PARTICLES

(71) Applicant: DEXERIALS CORPORATION, Shinagawa-ku, Tokyo (JP)

(72) Inventor: Motoki SUMA, Tokyo (JP)

(73) Assignee: DEXERIALS CORPORATION, Shinagawa-ku, Tokyo (JP)

(21) Appl. No.: 17/262,843

(22) PCT Filed: Jul. 19, 2019
(86) PCT No.: PCT/JP2019/028567

§ 371 Date: Jan. 25, 2021

(30) Foreign Application Priority Data
Jul. 26, 2018 (JP) 2018-140617

(51) Int. Cl. C08F 12/36

(52) U.S. Cl. CPC C08F 12/36

(57) ABSTRACT

Provided are resin particles, including: a vinyl polymer containing divinyl benzene as a constituent, wherein a number average particle diameter of the resin particles is 2.5 micrometers or greater but 10.0 micrometers or less, wherein a coefficient of variation (CV value) of a number-based particle diameter of the resin particles is 20% or lower, and wherein a circularity of the resin particles is 0.990 or greater.

### TECHNICAL FIELD

The present invention relates to resin particles and a method for producing resin particles.

### BACKGROUND ART

Resin particles such as porous resin particles are used in such applications as additives (e.g., delustrants) for coating agents such as paints and inks, light diffusing agents for optical applications (e.g., optical members such as lamp covers, light diffusing plates, or optical sheets), and adsorbents for filtrator cartridges.

It is preferable that resin particles used in such applications have a narrow particle size distribution. Hence, resin particles are produced according to, for example, a seed polymerization method (for example, see PTL 1).

However, although resin particles are required to have a small size and a high monodispersity, it is difficult to obtain a high monodispersity by production of resin particles according to a seed polymerization method.

Hence, currently, resin particles having a small size and a high monodispersity are demanded.

### CITATION LIST

### Patent Literature

PTL 1: Japanese Patent Application Laid-Open No. 2014-198785

### SUMMARY OF INVENTION

### Technical Problem

The present invention aims for achieving an object described below.

That is, the present invention has an object to provide resin particles having a small size and a high monodispersity and a method for producing such resin particles.

### Solution to Problem

Means for solving the above problems are as follows.

<1> Resin particles, including:

a vinyl polymer containing &vinyl benzene as a constituent,

wherein a number average particle diameter of the resin particles is 2.5 micrometers or greater but 10.0 micrometers or less,

wherein a coefficient of variation (CV value) of a number-based particle diameter of the resin particles is 20% or lower, and

wherein a circularity of the resin particles is 0.990 or greater.

<2> The resin particles according to <1>,

wherein the vinyl polymer contains a monomer containing one polymerizable double bond as a constituent.

<3> The resin particles according to <1> or <2>,

wherein the resin particles are porous,

wherein a pore diameter of the resin particles is 10 angstroms or greater but 950 angstroms or less, and

wherein a specific surface area of the resin particles is 10 m²/g or greater but 600 m²/g or less.

<4> The resin particles according to <3>,

wherein a pore volume of the resin particles is 0.1 cm³/g or greater but 2.0 cm³/g or less.

<5> A method for producing the resin particles according to any one of <1> to <4>, the method including:

sending a mixture liquid containing: a monomer including divinyl benzene; and a polymerization initiator into a continuous phase through a microchannel, to produce an emulsion in which dispersed phases formed of the mixture liquid are dispersed in the continuous phase; and

heating the emulsion to polymerize the monomer, to obtain the resin particles, which are the vinyl polymer.

<6> The method for producing the resin particles according to <5>,

wherein the monomer contains a monomer containing one polymerizable double bond.

<7> The method for producing the resin particles according to <5> or <6>,

wherein the mixture solution contains a solvent.

<8> The method for producing the resin particles according to <7>,

wherein the solvent is at least one selected from the group consisting of toluene, decane, tridecane, octane, and isooctane.

<9> The method for producing the resin particles according to any one of <5> to <8>,

wherein the continuous phase contains water.

### Advantageous Effects of Invention

The present invention can achieve the object described above and provide resin particles having a small size and a high monodispersity and a method for producing such resin particles.

### BRIEF DESCRIPTION OF DRAWINGS

FIG. 1A is a scanning electron microscopic image of an example of resin particles (at a magnification of ×5,000);

FIG. 1B is a scanning electron microscopic image of an example of resin particles (at a magnification of ×30,000);

FIG. 2 is a scanning electron microscopic image of a glass member for forming a microchannel;

FIG. 3 plots a compression force-displacement curve indicating results of a test performed five times on resin particles of Example 2 with a microcompression tester; and

FIG. 4 plots a compression force-displacement curve indicating results of a test performed five times on resin particles of Comparative Example 2 with a microcompression tester.

### DESCRIPTION OF EMBODIMENTS

### (Resin Particles)

Resin particles of the present invention contain a vinyl polymer containing divinyl benzene as a constituent, and have the following characteristics.

(1) The number average particle diameter is 2.5 micrometers or greater but 10.0 micrometers or less.

(2) A coefficient of variation (CV value) of a number-based particle diameter is 20% or lower.

(3) The circularity is 0.990 or greater.

### <Vinyl Polymer>

The resin particles contain a vinyl polymer. For example, the resin particles are the vinyl polymer itself.

The vinyl polymer contains at least divinyl benzene as a constituent, and preferably contains a monomer containing one polymerizable double bond (hereinafter, may be referred to as “monofunctional monomer”) as a constituent. In other words, the vinyl polymer is a polymer obtained by polymerization of a monomer containing at least divinyl benzene. Examples of the polymerization include radical polymerization.

When the vinyl polymer contains divinyl benzene as a constituent, resin particles that are not easily broken by external forces and are applicable to various purposes can be obtained.

### <<Monomer Containing One Polymerizable Double Bond (Monofunctional Monomer)>>

The monofunctional monomer is not particularly limited and may be appropriately selected depending on the intended purpose so long as the monofunctional monomer is a compound containing only one polymerizable double bond in a molecule thereof.

Examples of the monofunctional monomer include substituted or unsubstituted (meth)acrylates, substituted or unsubstituted styrenes, substituted or unsubstituted acrylamides, vinyl group-containing monomers (e.g., vinyl esters, vinyl ethers, and N-vinylamides), and (meth)acrylic acid.

Examples of the monofunctional monomer include styrene or derivatives of styrene, (meth)acrylic acid ester, vinyl ester, N-vinyl compounds, and fluorine-containing monomers.

Examples of the styrene or derivatives of styrene include styrene, α-methylstyrene, m-methylstyrene, p-methylstyrene (4-methylstyrene), α-methylstyrene o-ethylstyrene, m-ethylstyrene, p-ethylstyrene, 2,4-dimethylstyrene, p-n-butylstyrene, p-t-butylstyrene, p-n-hexylstyrene, p-n-octylstyrene, p-n-nonylstyrene, p-n-decylstyrene, p-n-dodecylstyrene, p-methoxystyrene, p-phenylstyrene, p-chlorostyrene and 3,4-dichlorostyrene.

Examples of the (meth)acrylic acid ester include methyl acrylate, ethyl acrylate, propyl acrylate, n-butyl acrylate, isobutyl acrylate, hexyl acrylate, 2-ethylhexyl acrylate, n-octyl acrylate, dodecyl acrylate, lauryl acrylate, stearyl acrylate, glycidyl acrylate, 2-chloroethyl acrylate, phenyl acrylate, methyl α-chloroacrylate, methyl methacrylate, ethyl methacrylate, propyl methacrylate, n-butyl methacrylate, isobutyl methacrylate, hexyl methacrylate, 2-ethylhexyl methacrylate, n-octyl methacrylate, dodecyl methacrylate, lauryl methacrylate, stearyl methacrylate, and glycidyl methacrylate.

Examples of the vinyl ester include vinyl acetate, vinyl propionate, vinyl benzoate, and vinyl butyrate.

Examples of the N-vinyl compounds include N-vinylpyrrole, N-vinylcarbazole, N-vinylindole, and N-vinylpyrrolidone.

Examples of the fluorine-containing monomers include vinyl fluoride, vinylidene fluoride, tetrafluoroethylene, hexafluoropropylene, trifluoroethyl acrylate, and tetrafluoropropyl acrylate.

One of these monofunctional monomers may be used alone or two or more of these monofunctional monomers may be used in combination.

The molecular weight of the monofunctional monomer is not particularly limited, may be appropriately selected depending on the intended purpose, and is preferably 70 or greater but 500 or less, more preferably 80 or greater but 300 or less, and particularly preferably 100 or greater but 200 or less.

It is preferable that the resin particles not function as a catalyst (e.g., an asymmetric catalyst) of a chemical reaction. In this regard, it is preferable that the vinyl polymer not contain a monomer containing an asymmetric source as a constituent.

Examples of the asymmetric source of the monomer containing the asymmetric source include proline derivatives.

It is preferable that the resin particles be transparent particles. In this regard, it is preferable that the vinyl polymer not contain a monomer containing a pigment derivative as a constituent.

Examples of the pigment derivative of the monomer containing the pigment derivative include phthalocyanine derivatives.

The ratio of the divinyl benzene in the constituents of the vinyl polymer is not particularly limited, may be appropriately selected depending on the intended purpose, and is preferably 10% by mass or greater but 100% by mass or less relative to all monomers serving as constituents.

When the constituents of the vinyl polymer include the monofunctional monomer, the ratio of the divinyl benzene in the constituents of the vinyl polymer is preferably 10% by mass or greater but 70% by mass or less relative to all monomers serving as constituents.

The ratio of the monofunctional monomer in the constituents of the vinyl polymer is not particularly limited, may be appropriately selected depending on the intended purpose, and is preferably 0% by mass or greater but 90% by mass or less.

When the constituents of the vinyl polymer include the monofunctional monomer, the ratio of the monofunctional monomer in the constituents of the vinyl polymer is preferably 30% by mass or greater but 90% by mass or less relative to all monomers serving as constituents.

When the constituents of the vinyl polymer include the monofunctional monomer and the monofunctional monomer is the styrene or a derivative of styrene, the ratio of the styrene or a derivative of styrene in the constituents of the vinyl polymer is not particularly limited, may be appropriately selected depending on the intended purpose, and is preferably 30% by mass or greater but 70% by mass or less and more preferably 40% by mass or greater but 60% by mass or less.

When the constituents of the vinyl polymer include the monofunctional monomer and the monofunctional monomer is the (meth)acrylic acid ester, the ratio of the (meth)acrylic acid ester in the constituents of the vinyl polymer is not particularly limited, may be appropriately selected depending on the intended purpose, and is preferably 40% by mass or greater but 90% by mass or less and more preferably 70% by mass or greater but 90% by mass or less.

<Number average particle diameter>

The number average particle diameter of the resin particles is 2.5 micrometers or greater but 10.0 micrometers or less and preferably 2.5 micrometers or greater but 4.0 micrometers or less.

The number average particle diameter can be calculated from a particle size distribution measured according to, for example, an imaging method.

Specifically, for example, a particle size distribution can be measured according to the measuring method described below.

Measuring instrument: F-PIA3000 (Malvern)

Imaging method: A particle size distribution is measured by direct imaging of the particles by irradiation with strobe light.

Measurement sample: a sample adjusted to a slurry particle concentration of from 5,000 particles/microliter through 100,000 particles/microliter in a CELLSHEATH solvent (Sysmex Corporation).

### <Coefficient of Variation (CV Value)>

A coefficient of variation (CV value) of a number-based particle diameter of the resin particles is 20% or lower, and preferably 18% or lower. The lower limit of the CV value is not particularly limited and may be appropriately selected depending on the intended purpose. The CV value may be 5% or greater or may be 8% or greater.

The CV value is an indicator of the degree of variation in data and generally calculated according to a formula descried below.

CV=standard deviation/average

The CV value as used herein is a coefficient of variation of a number-based particle diameter of the resin particles and calculated according to a formula described below.

CV=standard deviation of a number-based particle diameter/number average particle diameter

The CV value can be calculated from a particle size distribution measured by, for example, laser diffraction. A specific measuring method is the same as the measuring method for the number average particle diameter described above.

### <Circularity>

The circularity of the resin particles is 0.990 or greater, preferably 0.992 or greater, and more preferably 0.995 or greater.

The circularity indicates the degree of roughness on the surface of a particle, and means the Wadell's circularity. The circularity is calculated according to a formula described below.

Circularity indicating degree of roughness=perimeter of a circle having a projection area equal to a particle concerned/perimeter of the particle

The “perimeter of a circle having a projection area equal to a particle concerned” is the length of the contour of a circle calculated to have an area equal to the area of the shadow of a given particle appearing on an underneath flat surface when that particle is observed from a higher position perpendicular to the particle. The “perimeter of the particle” is the length of the contour of the shadow of the particle appearing on an underneath flat surface when the particle is observed from a higher position perpendicular to the particle.

The smaller the degree of roughness on the surface of a particle, the closer to one the circularity becomes.

It is preferable that the resin particles be close to a spherical shape. In this regard, the circularity is 0.990 or greater.

For measurement/evaluation of the circularity, an image obtained by measurement with F-PIA3000 (Malvern) is analyzed with image analyzing software named IMAGE PRO PLUS to obtain the area and the perimeter of particles, and the area and the perimeter are assigned in the formula for calculating the circularity. In this way, the circularity can be calculated.

The specific surface area of the resin particles is not particularly limited, may be appropriately selected depending on the intended purpose, and is, for example, 1.0 m²/g or greater but 600 m²/g or less.

The specific surface area is a BET specific surface area and can be measured with, for example, an accelerated surface area and porosimetry system ASAP-2020 (available from Micromeritics Instrument Corporation).

Examples of a gas used for the measurement include a nitrogen gas.

### <Porous Particles>

The resin particles are, for example, porous. That is, the resin particles are, for example, porous particles.

### <<Pore Diameter>>

The pore diameter of the porous resin particles is not particularly limited, may be appropriately selected depending on the intended purpose, and is preferably 10 angstroms or greater but 950 angstroms or less.

### <<Pore Volume>>

The pore volume of the porous resin particles is not particularly limited, may be appropriately selected depending on the intended purpose, and is preferably 0.1 cm³/g or greater but 2.0 cm³/g or less and more preferably 0.1 cm³/g or greater but 1.4 cm³/g or less.

### <<Specific Surface Area>>

The specific surface area of the porous resin particles is not particularly limited, may be appropriately selected depending on the intended purpose, and is preferably 10 m²/g or greater but 600 m²/g or less, more preferably 100 m²/g or greater but 600 m²/g or less, and particularly preferably 250 m²/g or greater but 550 m²/g or less.

The pore diameter, the pore volume, and the specific surface area can be measured with, for example, an accelerated surface area and porosimetry system ASAP-2020 (available from Micromeritics Instrument Corporation).

The specific surface area is a BET specific surface area.

Examples of a gas used for the measurement include a nitrogen gas.

This instrument is configured to adsorb gas molecules having a known adsorption occupation area to the surface of powder particles, and calculate the specific surface area of the sample based on the amount of the gas molecules adsorbed or measure the pore size distribution based on condensation of the gas molecules.

### <Ion Content>

When the resin particles are used for various applications, ion contained in the resin particles may give adverse influence. For example, when the resin particles are used as an adsorbent of a filtrator cartridge for a cleaning liquid in semiconductor fabrication, any ions contained in the resin particles transfer to the semiconductor to be fabricated and give adverse influence to the semiconductor. In this regard, it is preferable that the ion content in the resin particles be low. For example, the preferable range of the ion content is as follows.

The content of sodium cations (Na⁺) in the resin particles is preferably 0.5 ppm or less and more preferably 0.3 ppm or less.

The content of ammonium cations (NH₄⁺) in the resin particles is preferably 0.5 ppm or less and more preferably 0.3 ppm or less.

The content of magnesium cations (Mg⁺) in the resin particles is preferably 0.1 ppm or less and more preferably less than 0.05 ppm.

The content of calcium cations (Ca⁺) in the resin particles is preferably 0.1 ppm or less and more preferably less than 0.05 ppm.

The content of fluorine anions (F⁻) in the resin particles is preferably 0.1 ppm or less and more preferably less than 0.05 ppm.

The content of acetic acid anions (CH₃COO⁻) in the resin particles is preferably 1.0 ppm or less and more preferably 0.5 ppm or less.

The content of propionic acid anions (C₂H₅COO⁻) in the resin particles is preferably 0.1 ppm or less and more preferably less than 0.05 ppm.

The content of formic acid anions (HCOO⁻) in the resin particles is preferably 3.0 ppm or less and more preferably 2.0 ppm or less.

The content of chlorine anions (Cl⁻) in the resin particles is preferably 1.5 ppm or less and more preferably 0.1 ppm or less.

The content of bromine anions (Br⁻) in the resin particles is preferably 0.2 ppm or less and more preferably 0.1 ppm or less.

The ion content in the resin particles can be measured by, for example, ion chromatography.

For example, the measurement sample is prepared according to the method described below.

### [Preparation of Measurement Sample]

The resin particles (0.2 g) are put in a 50 mL polypropylene container together with ultrapure water (10 mL). The container is left to stand in an oven of 100 degrees C. for 10 hours. In this way, ions in the resin particles are extracted into the water. Subsequently, the resin particles are removed from the water, to obtain the water containing the ions that have been contained in the resin particles. This water is used as the measurement sample.

### <Residual Monomer>

When the resin particles are used for various applications, any residual monomer contained in the resin particles may give adverse influence. For example, because a residual monomer is a volatile component, it is preferable that the content of a residual monomer in the resin particles be low for applications in which presence of a volatile component is undesirable (for example, applications in which the resin particles are exposed to a high temperature). For example, the preferable range of the content of a residual monomer is as follows.

The content of the divinyl benzene monomer in the resin particle is preferably 30 ppm or less, more preferably 20 ppm or less, and particularly preferably 15 ppm or less.

The content of a multifunctional monomer in the resin particles is preferably 5 ppm or less and more preferably 1 ppm or less.

The content of a residual monomer in the resin particles can be measured by, for example, a liquid chromatograph mass spectrometry (LC/MS) method.

For example, the measurement sample is prepared according to the method described below.

### [Preparation of Measurement Sample]

The resin particles (10% by mass) are added in acetonitrile and any residual monomer in the resin particles is extracted into acetonitrile, to obtain the measurement sample.

### <Color Change>

It is preferable that the resin particles undergo little color change. In this regard, change in b* of the L*a*b* color space of the resin particles between before and after the resin particles are heated at 150 degrees C. is preferably 5.0 or less and more preferably 4.0 or less.

Typically, resin particles become yellowish along with deterioration. Therefore, it is preferable that change in b*, which is the direction toward yellow in the L*a*b* color space, be small (i.e., change in b* is an indicator of deterioration).

The L*a*b* value of the resin particles can be obtained according to JIS Z 8729 “color display method-L*a*b* color system” using, for example, a color difference meter (e.g., CR-400, available from Konica Minolta Sensing, Inc.).

For example, the measurement sample is prepared according to the method described below.

### [Preparation of Measurement Sample]

### [Sample Before Heating]

The resin particles are ground in a mortar, and 2.5 g of the resultant is loaded in a measuring container (a powder cell “CR-A50” available from Konica Minolta Sensing, Inc.).

[Sample after Heating]

The resin particles put in an aluminum foil container are heated for two hours in a thermostat chamber of 150 degrees C. and subsequently ground in a mortar, and 2.5 g of the resultant is loaded in a measuring container (a powder cell “CR-A50” available from Konica Minolta Sensing, Inc.).

### <Compression Strength>

The compression strength of the resin particles is not particularly limited and may be appropriately selected depending on the intended purpose. The 20% compression strength of the resin particles is preferably 5 Mpa or greater but 100 Mpa or less.

When the resin particles are porous particles, the 20% compression strength of the resin particles is preferably 5 Mpa or greater but 40 Mpa or less.

When the resin particles are not porous particles, the 20% compression strength of the resin particles is preferably 50 Mpa or greater but 100 Mpa or less.

The 20% compression strength can be measured with, for example, a microcompression tester (MCMT-200, available from Shimadzu Corporation) under the conditions described below. The 20% compression strength is an arithmetic mean of the results of the test performed five times.

### [Measurement Conditions]

MCT CSV File Version; 1000
Kind of indenter: FLAT50
Magnification of object lens: 50
Calculated compression force: 20%
Test mode: compression test
Sample form: particles
Condition for terminating the test: when a set test force is reached
Test force: 25 mN
Loading rate: 1 (0.3331 mN/sec)
Loading retention time: 0 sec
Number of times to perform actual test: 5

The standard deviation (o) of the 20% compression strength of the resin particles is not particularly limited, may be appropriately selected depending on the intended purpose, and is preferably 10 or less and more preferably 5 or less.

The standard deviation is a standard deviation of, for example, the results of the test performed five times.

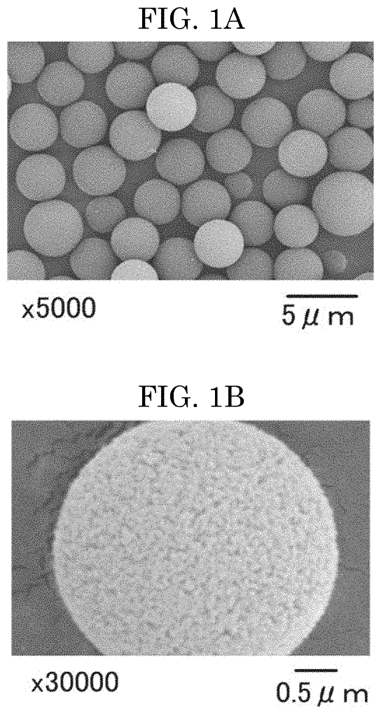

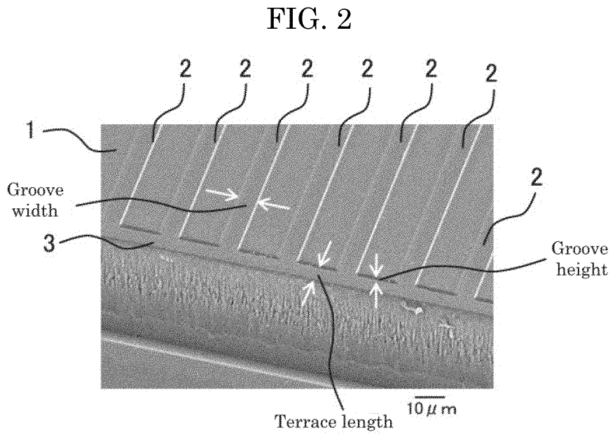

FIG. 1A and FIG. 1B illustrate scanning electron microscopic images of an example of resin particles of the present invention.

The resin particles of FIG. 1A and FIG. 1B have the following characteristics.

Number average particle diameter: 3.36 micrometers

CV value: 15.2%

Pore diameter: 234 angstroms

Specific surface area: 451 m²/g

Pore volume: 1.09 cm³/g

The method for producing the resin particles is preferably the method for producing resin particles of the present invention described below.

### (Method for Producing Resin Particles)

The method for producing resin particles of the present invention includes at least an emulsion producing step and a polymerization step, and further includes other steps as needed.

The method for producing the resin particles is the method for producing resin particles of the present invention.

### <Emulsion Producing Step>

The emulsion producing step is a step of sending a mixture liquid containing: a monomer including divinyl benzene; and a polymerization initiator into a continuous phase through a microchannel, to produce an emulsion in which dispersed phases formed of the mixture liquid are dispersed in the continuous phase.

### <<Mixture Liquid>>

The mixture liquid contains at least a monomer and a polymerization initiator, and further contains other components such as a solvent as needed.

### <<<Monomer>>>

The monomer includes at least divinyl benzene, and further includes other components such as a monomer containing one polymerizable double bond as needed.

Examples of the monomer containing one polymerizable double bond include the monomers containing one polymerizable double bond (monofunctional monomers) raised as examples in the description of the resin particles.

The ratio of the divinyl benzene in the monomer is not particularly limited, may be appropriately selected depending on the intended purpose, and is preferably 10% by mass or greater but 100% by mass or less relative to the monomer.

When the monomer includes the monofunctional monomer, the ratio of divinyl benzene in the monomer is preferably 10% by mass or greater but 70% by mass or less relative to the monomer.

The ratio of the monofunctional monomer in the monomer is not particularly limited, may be appropriately selected depending on the intended purpose, and is preferably 0% by mass or greater but 90% by mass or less relative to the monomer.

When the monomer includes the monofunctional monomer, the ratio of the monofunctional monomer in the monomer is preferably 30% by mass or greater but 90% by mass or less relative to the monomer.

When the monomer includes the monofunctional monomer and the monofunctional monomer is the styrene or a derivative of styrene, the ratio of the styrene or a derivative of styrene in the monomer is not particularly limited, may be appropriately selected depending on the intended purpose, and is preferably 30% by mass or greater but 70% by mass or less and more preferably 40% by mass or greater but 60% by mass or less relative to the monomer.

When the monomer includes the monofunctional monomer and the monofunctional monomer is the (meth)acrylic acid ester, the ratio of the (meth)acrylic acid ester in the monomer is not particularly limited, may be appropriately selected depending on the intended purpose, and is preferably 40% by mass or greater but 90% by mass or less and more preferably 70% by mass or greater but 90% by mass or less relative to the monomer.

### <<<Polymerization Initiator>>>

The polymerization initiator is not particularly limited and may be appropriately selected depending on the intended purpose so long as the polymerization initiator can polymerize the monomer. Examples of the polymerization initiator include persulfates, azo compounds, and peroxides.

Examples of the persulfates include potassium persulfate and ammonium persulfate.

Examples of the azo compounds include 4,4′-azobis(4-cyanovaleric acid), 2,2′-azobis(2-amidinopropane) dihydrochloride, 2,2′-azobis-2-methyl-N-1,1′-bis(hydroxymethyl)-2-hydroxyethyl propionamide, 2,2′-azobis(2,4-dimethylvaleronitrile), 2,2′-azobis isobutyronitrile, and 1,1′-azobis(1-cyclohexanecarbonitrile).

Examples of the peroxides include di-t-butyl peroxide, acetyl peroxide, dicumyl peroxide, dilauroyl peroxide, benzoyl peroxide, t-butyl peroxy-2-ethyl hexanoate, t-butyl perbutyl neodecanoate, t-hexyl peroxy 2-ethyl hexanoate, t-butyl peroxy pivalate, t-hexyl peroxy pivalate, di-isopropyl peroxy dicarbonate, di-t-butyl peroxy isophthalate, 1,1′,3,3′-tetramethyl butyl peroxy-2-ethyl hexanoate, and t-butyl peroxy isobutyrate.

The content of the polymerization initiator in the mixture liquid is not particularly limited, may be appropriately selected depending on the intended purpose, and is preferably 0.1% by mass or greater but 10% by mass or less, more preferably 0.5% by mass or greater but 7.0% by mass or less, and particularly preferably 0.7% by mass or greater but 5.0% by mass or less relative to the monomer.

### <<<Solvent>>>

When the mixture liquid contains the solvent, porous resin particles can be produced in the polymerization step described below.

The solvent is not particularly limited and may be appropriately selected depending on the intended purpose. Toluene, decane, tridecane, octane, and isooctane are preferable.

One of these solvents may be used alone or two or more of these solvents may be used in combination.

The content of the solvent in the mixture liquid is not particularly limited, may be appropriately selected depending on the intended purpose, and is preferably 10% by mass or greater but 90% by mass or less and more preferably 30% by mass or greater but 60% by mass or less relative to the mixture liquid.

### <<Microchannel>>

The microchannel is a fine flow path that has a width and a height of from a few hundreds of nanometers through a few micrometers and through which a liquid can flow.

### <<Continuous Phase>>

The continuous phase is not particularly limited and may be appropriately selected depending on the intended purpose so long as the mixture liquid can be dispersed as dispersed phases in the continuous phase. Examples of the continuous phase include water.

The water may contain a dispersion aid. Examples of the dispersion aid include polyvinyl alcohol and sodium alkyl diphenyl ether disulfonate.

The content of the dispersion aid in the dispersed phases is not particularly limited and may be appropriately selected depending on the intended purpose.

The emulsion producing step will be described with reference to the drawings.

FIG. 1 is a scanning electron microscopic image (SEM image) of a glass member for forming a microchannel.

The glass member 10 of FIG. 1 is produced by photolithographic processing of a glass plate 1. The glass member 10 includes a plurality of grooves 2 and a terrace portion 3.

The plurality of grooves 2 have a predetermined width and a predetermined depth (groove height).

The terrace portion 3 is formed at ends of the glass plate 1 in a manner to communicate with the plurality of grooves 2 and have the same depth as the plurality of grooves 2.

When a glass plate is overlaid on the glass member 10 of FIG. 1 in a manner to cover the grooves 2, the plurality of grooves 2 function as a plurality of microchannels, and the terrace portion 3 functions as a terrace.

The groove width of the glass member 10 of FIG. 1 is the width of the microchannels (flow path width), and the groove height of the glass member is the depth of the microchannels (flow path depth).

When pressure is applied to the mixture liquid to cause the mixture liquid to flow into the microchannels formed of the glass member 10 on which the glass plate is overlaid, the mixture liquid passes through the microchannels and reaches the terrace. When the mixture liquid falls from the terrace to below the terrace, the mixture liquid change into liquid droplets. A continuous phase flows below the terrace, and the liquid droplets that have fallen into the continuous phase become dispersed phases. In this way, an emulsion in which dispersed phases formed of the mixture liquid are dispersed in the continuous phase is obtained.

The flow rate at which the mixture liquid is passed through the microchannels is not particularly limited, may be appropriately selected depending on the intended purpose, and may be, for example, 0.5 mL/hour or greater but 10 mL/hour or lower.

The mass ratio (dispersed phase/continuous phase) between the continuous phase and the dispersed phases in the emulsion is not particularly limited, may be appropriately selected depending on the intended purpose, and may be, for example, 1% or greater but 15% or less.

The liquid temperature of the continuous phase during production of the emulsion is not particularly limited, may be appropriately selected depending on the intended purpose, and may be, for example, 3 degrees C. or higher but 20 degrees C. or lower.

### <Polymerization Step>

The polymerization step is not particularly limited and may be appropriately selected depending on the intended purpose so long as the polymerization step is a step of heating the emulsion to polymerize the monomer, to obtain the resin particles, which are the vinyl polymer.

The polymerization temperature in the polymerization step is not particularly limited, may be appropriately selected depending on the intended purpose, and may be, for example, 70 degrees C. or higher but 110 degrees C. or lower.

The polymerization time in the polymerization step is not particularly limited, may be appropriately selected depending on the intended purpose, and may be, for example, 1 hour or longer but 24 hours or shorter.

With the use of the microchannels, the method for producing resin particles of the present invention can form dispersed phases (liquid droplets) having a small size and a high monodispersity in the continuous phase in the emulsion producing step. As a result, the method for producing resin particles of the present invention can produce resin particles having a small size and a high monodispersity.

### EXAMPLES

The present invention will be described below by way of Examples. The present invention should not be construed as being limited to these Examples.

### Example 1

Using the glass member illustrated in FIG. 1, resin particles were produced according to the method for producing resin particles of the present invention. Specifically, resin particles were produced according to the method described below.

A mixture liquid having the mix proportion presented in Table 1-1 was passed through microchannels produced by overlaying a glass plate on a microchannel (MC) substrate, which was the glass member illustrated in FIG. 1 and had the pattern dimensions presented in Table 1-1, to let the mixture liquid fall from the terrace into a continuous phase presented in Table 1-1, to obtain an emulsion. PELEX SS-L (obtained from Kao Corporation, sodium alkyl diphenyl ether disulfonate) (1.0% by mass) was added in the continuous phase (water).

Next, the temperature of the obtained emulsion was raised to 85±5 degrees C. in one hour under nitrogen bubbling, and then the obtained emulsion was retained in the state for 15 hours, to polymerize the monomer and obtain resin particles.

Various other conditions are presented below.

### [Various Conditions]

Transportation of mixture liquid: syringe pump
Transportation of continuous phase: double plunger pump
Transportation amount of mixture liquid: from 1 ml/hour through 5 ml/hour
Mixture liquid/continuous phase: from 5% by mass through 10% by mass
Emulsifying temperature: from 5 degrees C. through 15 degrees C.

### [Measurement]

The following characteristics of the obtained resin particles were measured according to the following measuring methods. The results are presented in Table 1-1.

### <Number Average Particle Diameter>

The number average particle diameter was obtained based on a particle size distribution measured according to an imaging method.

Specifically, a particle size distribution was measured according to the measuring method described below.

Measuring instrument: F-PIA3000 (Malvern)

Imaging method: A particle size distribution was measured by direct imaging of the particles by irradiation with strobe light.

Measurement sample: A sample adjusted to a slurry particle concentration of from 5,000 particles/microliter through 100,000 particles/microliter in a CELLSHEATH solvent (Sysmex Corporation) was used.

### <Coefficient of Variation (CV Value)>

The CV value was obtained based on a particle size distribution measured by laser diffraction. A specific measuring method is the same as the measuring method for the number average particle diameter described above.

### <Circularity>

The circularity was calculated by assigning the area and the perimeter of the particles, which were obtained using image analyzing software named IMAGE PRO PLUS, in the formula for calculating the circularity.

### <Pore Diameter/Pore Volume/Specific Surface Area>

The pore diameter, the pore volume, and the specific surface area were measured with an accelerated surface area and porosimetry system ASAP-2020 (available from Micromeritics Instrument Corporation).

The specific surface area is the BET specific surface area.

As the gas used for measurement, a nitrogen gas was used.

### Examples 2 to 15

Resin particles were produced in the same manner as in Example 1, except that unlike in Example 1, for example, the mix proportion of the mixture liquid and the pattern dimensions of the MC substrate were changed to, for example, the mix proportion of the mixture liquid and the pattern dimensions of the MC substrate presented in Table 1-1 and Table 1-2.

Various measurements of the obtained resin particles were performed in the same manners as in Example 1. The results are presented in Table 1-1 and Table 1-2.

TABLE 1-1

| | | | Ex. | | | | | | |
|---|---|---|---|---|---|---|---|---|---|
| | | | 1 | 2 | 3 | 4 | 5 | 6 | 7 |
| Mixture liquid | Monomer | A | 52.6% | 18.1% | 31.3% | 32.2% | | 31.3% | 32.2% |
| | | B | | | | | | | |
| | | C | 45.1% | 22.6% | 26.7% | 27.3% | 49.5% | 26.7% | 27.3% |
| | Polymerization | D | | | | | 1.0% | | |
| | initiator | E | 2.3% | | 0.9% | 0.9% | | 0.9% | 0.9% |
| | | F | | 3.3% | | | | | |
| | Solvent | G | | 56.1% | 31.2% | | 49.5% | 31.2% | |
| | | H | | | 9.9% | 39.6% | | 9.9% | 39.6% |

| Total (% by ass) | | 100.0% | 100.0% | 100.0% | 100.0% | 100.0% | 100.0% | 100.0% |
|---|---|---|---|---|---|---|---|---|
| DVB amount in monomer (% by mass) | | 46.2% | 55.6% | 46.0% | 45.9% | 100.0% | 46.0% | 45.9% |
| Continuous phase | SS-L (% by mass) | 1.0% | | | | 1.0% | | |
| (aqueous phase) | PVA (% by mas) | | 2.0% | 2.0% | 2.0% | | 2.0% | |

| | | | | |
|---|---|---|---|---|
| Emulsification | MC substrate | Flow path width | 6.0 ± 0.1 | 6.0 ± 0.1 |
| | pattern | (micrometer) | | |
| | dimension | Flow path depth | 0.75 ± 0.01 | 1.40 ± 0.1 |
| | | (micrometer) | | |
| | | Terrace length | 6.0 ± 0.1 | 15.0 ± 0.1 |
| | | (micrometer) | | |

| | | | | | | | | |
|---|---|---|---|---|---|---|---|---|
| Characteristic | Number average particle | 3.89 | 3.31 | 3.47 | 3.83 | 3.26 | 7.12 | 7.83 |
| measurement | diameter (micrometer) | | | | | | | |
| result | CV value (%) | 16.6 | 9.9 | 13.0 | 12.7 | 17.3 | 10.7 | 9.7 |
| | Circularity | 0.995 | 0.995 | 0.995 | 0.995 | 0.995 | 0.995 | 0.995 |
| | Pore diameter (angstrom) | Un-measurable | 23 | 39 | 286 | 902 | 39 | 283 |
| | Pore volume (cm³/g) | 0.01 | 0.18 | 0.47 | 0.93 | 1.27 | 0.47 | 0.97 |
| | Specific surface | 3 | 285 | 433 | 508 | 525 | 428 | 501 |
| | area (m²/g) | | | | | | | |

TABLE 1-2

| | | | Ex. | | | | | | | |
|---|---|---|---|---|---|---|---|---|---|---|
| | | | 8 | 9 | 10 | 11 | 12 | 13 | 14 | 15 |
| Mixture liquid | Monomer | A | | | | | | | | |
| | | B | 81.2% | 42.1% | 39.7% | 37.2% | 34.8% | 81.2% | 79.2% | 74.3% |
| | | C | 17.8% | 42.1% | 39.7% | 37.2% | 34.8% | 17.8% | 19.8% | 24.8% |
| | Polymerization | D | 1.0% | 0.8% | 0.8% | 0.7% | 0.7% | 1.0% | 1.0% | 1.0% |
| | initiator | E | | | | | | | | |
| | | F | | | | | | | | |
| | Solvent | G | | | | | | | | |
| | | H | | 14.9% | 19.8% | 24.8% | 29.8% | | | |

| Total (% by ass) | | 100.0% | 100.0% | 100.0% | 100.0% | 100.0% | 100.0% | 100.0% | 100.0% |
|---|---|---|---|---|---|---|---|---|---|
| DVB amount in monomer | | 18.0% | 50.0% | 50.0% | 50.0% | 50.0% | 18.0% | 20.0% | 25.0% |
| (% by mass) | | | | | | | | | |
| Continuous phase | SS-L (% by mass) | 1.0% | 1.0% | 1.0% | 1.0% | 1.0% | 1.0% | 1.0% | 1.0% |
| (aqueous phase) | PVA (% by mas) | | | | | | | | |

| | | | | |
|---|---|---|---|---|
| Emulsification | MC substrate | Flow path width | 6.0 ± 0.1 | 6.0 ± 0.1 |
| | pattern | (micrometer) | | |
| | dimension | Flow path depth | 0.75 ± 0.01 | 1.40 ± 0.1 |
| | | (micrometer) | | |
| | | Terrace length | 6.0 ± 0.1 | 15.0 ± 0.1 |
| | | (micrometer) | | |

| | | | | | | | | | |
|---|---|---|---|---|---|---|---|---|---|
| Characteristic | Number average particle | 2.59 | 2.88 | 2.48 | 2.54 | 2.89 | 4.99 | 5.71 | 5.29 |
| measurement | diameter (micrometer) | | | | | | | | |
| result | CV value (%) | 14.8 | 6.0 | 15.0 | 6.9 | 8.9 | 6.5 | 15.8 | 10.5 |
| | Circularity | 0.995 | 0.995 | 0.995 | 0.995 | 0.995 | 0.992 | 0.992 | 0.993 |
| | Pore diameter | Un- | 40 | 49 | 147 | 527 | Un- | Un- | Un- |
| | (angstrom) | measurable | | | | | measurable | measurable | measurable |
| | Pore volume (cm³/g) | 0.01 | 0.24 | 0.31 | 0.51 | 0.67 | 0.00 | 0.00 | 0.00 |
| | Specific surface | 2.6 | 206 | 248 | 283 | 314 | 2.0 | 1.6 | 1.2 |
| | area (m²/g) | | | | | | | | |

The abbreviations in Table 1-1 and Table 1-2 stand for the following.

A: (o,m,p,a)-Methylstyrene, obtained from Tokyo Chemical Industry Co., Ltd.

B: Glycidyl (meth)acrylate, obtained from Tokyo Chemical Industry Co., Ltd.

C: Divinyl benzene, obtained from Nippon Steel & Sumitomo Chemical Co., Ltd

D: Dilauroyl peroxide, obtained from NOF Corporation

E: 2,2′-Azobis (2,4-dimethyl valeronitrile), obtained from FUJIFILM Wako Pure Chemical Corporation

F: Benzoyl peroxide, obtained from NOF Corporation

G: Toluene, obtained from FUJIFILM Wako Pure Chemical Corporation

H: Isooctane, obtained from FUJIFILM Wako Pure Chemical Corporation

DVB: Divinyl benzene

SS-L: PELEX SS-L (sodium alkyl diphenyl ether disulfonate aqueous solution), obtained from Kao Corporation

PVA: Polyvinyl alcohol, obtained from FUJIFILM Wako Pure Chemical Corporation

### Comparative Example 1

A mixture liquid having the same composition as the mixture liquid produced in Example 1 was added to an aqueous phase having the same composition as the continuous phase produced in Example 1, and then stirred with a homogenizer, to obtain an emulsion in which liquid droplets formed of the mixture liquid were dispersed in the aqueous phase.

The obtained emulsion was heated to 85±5 degrees C. for one hour under nitrogen bubbling, and then retained in the state for 15 hours, to polymerize the monomer and obtain resin particles.

The number average particle diameter and the CV value of the obtained resin particles were measured in the same manners as in Example 1. The results are as follows.

The number average particle diameter of the obtained resin particles was 4.0 micrometers, and the CV value of the obtained resin particles was 26.8%.

### Comparative Example 2

A mixture liquid having the same composition as the mixture liquid produced in Example 2 was added to an aqueous phase having the same composition as the continuous phase produced in Example 2, and then stirred with a homogenizer, to obtain an emulsion in which liquid droplets formed of the mixture liquid were dispersed in the aqueous phase.

The obtained emulsion was heated to 85±5 degrees C. for one hour under nitrogen bubbling, and then retained in the state for 15 hours, to polymerize the monomer and obtain resin particles.

The number average particle diameter and the CV value of the obtained resin particles were measured in the same manners as in Example 1. The results are as follows.

The number average particle diameter of the obtained resin particles was 3.5 micrometers, and the CV value of the obtained resin particles was 26.1%.

### Comparative Example 3

A mixture liquid having the same composition as the mixture liquid produced in Example 3 was added to an aqueous phase having the same composition as the continuous phase produced in Example 3, and then stirred with a homogenizer, to obtain an emulsion in which liquid droplets formed of the mixture liquid were dispersed in the aqueous phase.

The obtained emulsion was heated to 85±5 degrees C. for one hour under nitrogen bubbling, and then retained in the state for 15 hours, to polymerize the monomer and obtain resin particles.

The number average particle diameter and the CV value of the obtained resin particles were measured in the same manners as in Example 1. The results are as follows.

The number average particle diameter of the obtained resin particles was 5.1 micrometers, and the CV value of the obtained resin particles was 28.5%.

### Comparative Example 4

A mixture liquid having the same composition as the mixture liquid produced in Example 4 was added to an aqueous phase having the same composition as the continuous phase produced in Example 4, and then stirred with a homogenizer, to obtain an emulsion in which liquid droplets formed of the mixture liquid were dispersed in the aqueous phase.

The obtained emulsion was heated to 85±5 degrees C. for one hour under nitrogen bubbling, and then retained in the state for 15 hours, to polymerize the monomer and obtain resin particles.

The number average particle diameter and the CV value of the obtained resin particles were measured in the same manners as in Example 1. The results are as follows.

The number average particle diameter of the obtained resin particles was 7.7 micrometers, and the CV value of the obtained resin particles was 27.8%.

### Comparative Example 5

A mixture liquid having the same composition as the mixture liquid produced in Example 5 was added to an aqueous phase having the same composition as the continuous phase produced in Example 5, and then stirred with a homogenizer, to obtain an emulsion in which liquid droplets formed of the mixture liquid were dispersed in the aqueous phase.

The obtained emulsion was heated to 85±5 degrees C. for one hour under nitrogen bubbling, and then retained in the state for 15 hours, to polymerize the monomer and obtain resin particles.

The number average particle diameter and the CV value of the obtained resin particles were measured in the same manners as in Example 1. The results are as follows.

The number average particle diameter of the obtained resin particles was 5.4 micrometers, and the CV value of the obtained resin particles was 33.0%.

### Comparative Example 6

A mixture liquid having the same composition as the mixture liquid produced in Example 8 was added to an aqueous phase having the same composition as the continuous phase produced in Example 8, and then stirred with a homogenizer, to obtain an emulsion in which liquid droplets formed of the mixture liquid were dispersed in the aqueous phase.

The obtained emulsion was heated to 85±5 degrees C. for one hour under nitrogen bubbling, and then retained in the state for 15 hours, to polymerize the monomer and obtain resin particles.

The number average particle diameter and the CV value of the obtained resin particles were measured in the same manners as in Example 1. The results are as follows.

The number average particle diameter of the obtained resin particles was 3.9 micrometers, and the CV value of the obtained resin particles was 22.2%.

### [Evaluation]

### <Filterability>

Filterability of the resin particles of Examples 1, 2, 5, 8, and 9, and Comparative Examples 1 and 2 when used as an adsorbent of a filtrator cartridge was evaluated in the manner described below.

The resin particles were filled in a cartridge having an internal diameter of 3 mm and a length of 100 mm, and the time taken to filtrate an acrylic monomer (10 microliters) in a 1% solution at a flow rate of 1.0 ml/min was evaluated according to the evaluation criteria described below. The results are presented in Table 2. Examples 1, 2, 5, 8, and 9 were evaluated as representatives of Examples.

### [Evaluation Criteria]

A (good): The filtration time was within 5 minutes.

B (relatively good): The filtration time was longer than 5 minutes but shorter than 10 minutes.

C (bad): The filtration time was 10 minutes or longer.

TABLE 2

| | | | | | | Comp. | Comp. |
|---|---|---|---|---|---|---|---|
| | Ex. 1 | Ex. 2 | Ex. 5 | Ex. 8 | Ex. 9 | Ex. 1 | Ex. 2 |
| CV value (%) | 16.6 | 9.9 | 17.3 | 14.8 | 6.0 | 26.8 | 26.1 |
| Filtration | 5.0 | 3.5 | 5.9 | 4.2 | 2.6 | 10.2 | 14.0 |
| time (minute) | | | | | | | |
| Evaluation | B | A | B | A | A | C | C |

The resin particles of Examples having a small CV value and a high monodispersity took a short time for filtration and had an excellent filterability.

### <Ion Content>

The ion content in the resin particles of Examples 3, 4, and 8 was measured by ion chromatography. The results are presented in Table 3.

The measurement samples were prepared according to the method described below.

### [Preparation of Measurement Samples]

The resin particles (0.2 g) were put in a 50 mL polypropylene container together with ultrapure water (10 mL). The container was left to stand in an oven of 100 degrees C. for 10 hours. In this way, ions in the resin particles were extracted into the water. Subsequently, the resin particles were removed from the water, to obtain the water containing the ions that had been contained in the resin particles. This water was used as the measurement sample.

TABLE 3

| | | | | | Anion (ppm) | | | | | |
|---|---|---|---|---|---|---|---|---|---|---|
| | | | | | | Acetic | | Formic | | |
| | Cation (ppm) | | | | | acid | Propionic | acid | | |
| | Na⁺ | NH4⁺ | Mg2⁺ | Ca2⁺ | F⁻ | ion | acid ion | ion | Cl⁻ | Br⁻ |
| Ex. 3 | <0.05 | 0.127 | <0.05 | <0.05 | <0.05 | 0.41 | <0.05 | 1.917 | <0.05 | <0.05 |
| Ex. 4 | <0.05 | 0.069 | <0.05 | <0.05 | <0.05 | 0.354 | <0.05 | 1.386 | <0.05 | <0.05 |
| Ex. 8 | 0.299 | 0.042 | <0.05 | <0.05 | <0.05 | 0.28 | <0.05 | 1.456 | 1.498 | 0.127 |

The limit of detection was 0.05 ppm.

### <Residual Monomer>

The content of a residual monomer in the resin particles of Examples 3, 4, and 8 was measured by a liquid chromatograph mass spectrometry (LC/MS) method. The results are presented in Table 4.

The measurement samples were prepared according to the method described below.

### [Preparation of Measurement Samples]

The resin particles (10% by mass) were added in acetonitrile and any residual monomer in the resin particles was extracted into acetonitrile, to obtain the measurement sample.

TABLE 4

| | Styrene (ppm) | Divinyl benzene (ppm) |
|---|---|---|
| Ex. 3 | 0.6 | 0.5 |
| Ex. 4 | 278 | 10.8 |
| Ex. 8 | 0 | 16.4 |

### <Color Change>

The L*a*b* values of the resin particles of Examples 2, 3, 4, and 8 before and after heating were obtained according to JIS Z 8729 “color display method-L*a*b* color system” using a color difference meter (CR-400, obtained from Konica Minolta Sensing, Inc.). From the obtained values, change in b* value (Ab*) between before and after heating was obtained. The results are presented in Table 5.

The measurement samples were prepared according to the method described below.

### [Preparation of Measurement Samples]

### [Samples Before Heating]

The resin particles were ground with a mortar, and 2.5 g of the resultant was loaded in a measuring container (a powder cell “CR-A50” obtained from Konica Minolta Sensing, Inc.).

[Samples after Heating]

The resin particles put in an aluminum foil container were heated for two hours in a thermostat chamber of 150 degrees C. and subsequently ground in a mortar, and 2.5 g of the resultant was loaded in a measuring container (a powder cell “CR-A50” obtained from Konica Minolta Sensing, Inc.).

TABLE 5

| | Δb* |
|---|---|
| Ex. 2 | 3.57 |
| Ex. 3 | 2.88 |
| Ex. 4 | 2.27 |
| Ex. 8 | 2.87 |

### <Compression Strength>

The 20% compression strength of the resin particles of Examples 2 to 5 and 8, and Comparative Examples 2 to 6 was measured with a microcompression tester (MCMT-200, obtained from Shimadzu Corporation) under the conditions described below. The 20% compression strength is an arithmetic mean of the results of the test performed five times. The results are presented in Table 6.

### [Measurement Conditions]

MCT CSV File Version; 1000
Kind of indenter: FLAT50
Magnification of object lens: 50
Calculated compression force: 20%
Test mode: compression test
Sample form: particles
Condition for terminating the test: when a set test force was reached
Test force: 25 mN
Loading rate: 1 (0.3331 mN/sec)
Loading retention time: 0 sec
Number of times to perform actual test: 5

Furthermore, the standard deviation (o) of the 20% compression strength of the resin particles was calculated. The standard deviation was a standard deviation of the results of the test performed five times. The results are presented in Table 6.

TABLE 6

| | | Microcompression measurement result | | |
|---|---|---|---|---|
| | | | 20% compression | |
| | | 20% compression | strength (average | |
| | CV | strength | of 5 times) | Standard |
| | value | [Mpa] | [Mpa] | deviation σ |
| Ex. 2 | 9.9 | 28.9 | 26.2 | 2.6 |
| | | 25.6 | | |
| | | 23.8 | | |
| | | 23.9 | | |
| | | 28.9 | | |
| Comp. | 26.1 | 29.5 | 35.7 | 5.4 |
| Ex. 2 | | 31.8 | | |
| | | 34.6 | | |
| | | 40.1 | | |
| | | 42.3 | | |
| Ex. 3 | 13.0 | 21.5 | 25.5 | 3.1 |
| | | 25.9 | | |
| | | 25.8 | | |
| | | 30.1 | | |
| | | 24.4 | | |
| Comp. | 28.5 | 30.0 | 28.7 | 3.4 |
| Ex. 3 | | 30.7 | | |
| | | 29.5 | | |
| | | 22.7 | | |
| | | 30.6 | | |
| Ex. 4 | 12.7 | 12.2 | 14.1 | 1.7 |
| | | 15.9 | | |
| | | 13.4 | | |
| | | 15.8 | | |
| | | 13.4 | | |
| Comp. | 27.8 | 11.7 | 13.3 | 5.0 |
| Ex. 4 | | 15.4 | | |
| | | 12.3 | | |
| | | 20.3 | | |
| | | 6.8 | | |
| Ex. 5 | 17.3 | 10.4 | 8.9 | 5.4 |
| | | 11.9 | | |
| | | 5.2 | | |
| | | 1.8 | | |
| | | 15.4 | | |
| Comp. | 33.0 | 7.9 | 10.9 | 5.5 |
| Ex. 5 | | 12.8 | | |
| | | 19.1 | | |
| | | 10.1 | | |
| | | 4.6 | | |
| Ex. 8 | 14.8 | 68.3 | 73.3 | 4.6 |
| | | 76.6 | | |
| | | 76.6 | | |
| | | 76.6 | | |
| | | 68.3 | | |
| Comp. | 22.2 | 66.3 | 71.0 | 7.0 |
| Ex. 6 | | 72.0 | | |
| | | 61.6 | | |
| | | 78.6 | | |
| | | 76.4 | | |

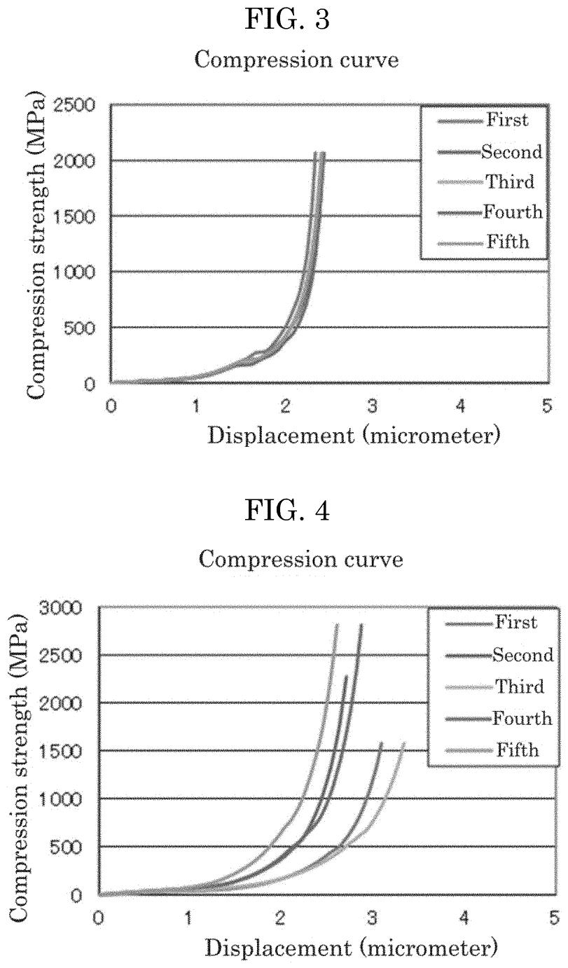

The compression force-displacement curve of FIG. 3 plots the results of the test performed five times on the resin particles of Example 2 with the microcompression tester.

A compression force-displacement curve of FIG. 4 plots the results of the test performed five times on the resin particles of Comparative Example 2 with the microcompression tester.

The compression force-displacement curves of the resin particles produced through the microchannels roughly overlap even when measurement was performed at N=5, whereas the resin particles produced with the homogenizer behaved nonuniformly. That is, the resin particles produced through the microchannels had a very small CV value, a very small standard deviation, and a small variation. On the other hand, the particles produced with the homogenizer had a large CV value, a large standard deviation, and a large variation. Hence, the particles produced through the microchannels can be said to be almost uniform.

It can be seen that the resin particles produced through the microchannels have a low repulsive force because the resin particles were displaced in response to loading.

### INDUSTRIAL APPLICABILITY

Because the resin particles of the present invention have a small size and a high monodispersity, the resin particles can be suitably used as additives for coating agents such as paints and inks, light diffusing agents for optical applications, and adsorbents for filtrator cartridges, and further in all kinds of applications in which a small size and a high monodispersity are required.

1. Resin particles, comprising:
a vinyl polymer containing divinyl benzene as a constituent,
wherein a number average particle diameter of the resin particles is 2.5 micrometers or greater but 10.0 micrometers or less,
wherein a coefficient of variation (CV value) of a number-based particle diameter of the resin particles is 20% or lower, and
wherein a circularity of the resin particles is 0.990 or greater.

2. The resin particles according to claim 1,
wherein the vinyl polymer contains a monomer containing one polymerizable double bond as a constituent.

3. The resin particles according to claim 141,
wherein the resin particles are porous,
wherein a pore diameter of the resin particles is 10 angstroms or greater but 950 angstroms or less, and
wherein a specific surface area of the resin particles is 10 m²/g or greater but 600 m²/g or less.

4. The resin particles according to claim 3,
wherein a pore volume of the resin particles is 0.1 cm³/g or greater but 2.0 cm³/g or less.

5. A method for producing resin particles, the method comprising:
sending a mixture liquid containing: a monomer including divinyl benzene; and a polymerization initiator into a continuous phase through a microchannel, to produce an emulsion in which dispersed phases formed of the mixture liquid are dispersed in the continuous phase; and
heating the emulsion to polymerize the monomer, to obtain resin particles, which are a vinyl polymer,
wherein the resin particles comprises a vinyl polymer containing divinyl benzene as a constituent,
wherein a number average particle diameter of the resin particles is 2.5 micrometers or greater but 10.0 micrometers or less,
wherein a coefficient of variation (CV value) of a number-based particle diameter of the resin particles is 20% or lower, and
wherein a circularity of the resin particles is 0.990 or greater.

6. The method for producing the resin particles according to claim 5,
wherein the monomer contains a monomer containing one polymerizable double bond.

7. The method for producing the resin particles according to claim 5,
wherein the mixture solution contains a solvent.

8. The method for producing the resin particles according to claim 7,
wherein the solvent is at least one selected from the group consisting of toluene, decane, tridecane, octane, and isooctane.

9. The method for producing the resin particles according to claim 5,
wherein the continuous phase contains water.
